(19) United States
(12) Patent Application Publication
(10) Pub. No.: US 2017/0212996 A1
(43) Pub. Date: Jul. 27, 2017

(54) INSURANCE DATA MANAGEMENT PLATFORM

(71) Applicant: FC Advisors, LLC, Philadelphia, PA (US)

(72) Inventors: Charles E. Stauber, Ambler, PA (US); Robert M. Cavalier, Philadelphia, PA (US); George J. Awad, Philadelphia, PA (US)

(21) Appl. No.: 15/018,900

(22) Filed: Feb. 9, 2016

Related U.S. Application Data
(60) Provisional application No. 62/286,627, filed on Jan. 25, 2016.

(51) Int. Cl. G06F 19/00

(52) U.S. Cl. CPC G06F 19/328

(57) ABSTRACT

Current systems for insurance data management do not avail for the creation of customizable future care insurance plans. Described herein are computer-implemented interactive systems and methods allowing for the creation, management, storage, retrieval, and communication of data representative of at least one customizable future care insurance plan. The systems and methods permit the creation of customizable future care insurance plans based on an agreed to future medical care plan through the cooperation of various cooperating third party providers (i.e., self-selected and/or selected based on defined criteria) specifically containing at a minimum at least one excess coverage above a primary health plan providing band coverage to ensure the that the agreed to future medical care plan is deployed throughout the life-term of the intended covered party.

### BACKGROUND

Currently, there are various insurance products available to persons, corporations, governmental authorities, and others to provide coverage for a myriad of different types of risk and exposure that can be experienced by the party (parties) seeking such coverage. The scope, coverage, and costs for such products are defined by the insurance carrier underwriting the level of risk associated with each of these products. Generally, insurance carriers focus their product offerings on a specific line of business to either take direct primary risk and/or excess risk for a particular risk type. For example, an insurance carrier may choose to underwrite primary risk for parties who seek coverage specifically for adverse events that could occur to their property or them personally (e.g., casualty). Such line of business is generally referred to as a Property & Casualty (P&C) line of business. Other insurance carriers may choose to underwrite risk as it relates to a person's health (e.g., Accident & Health line of business).

In the context of P&C products, such products generally offer coverage for various types of injury to person or property sustained as a result of the covered parties' conduct. Included in such coverage are personal injuries to third parties arising from an auto accident wherein such auto is owned/operated by the covered party, injuries sustained by a product/service sold by the covered party, injuries sustained on the covered party's property, etc. Unfortunately, at times the scope of the injuries can reach to a catastrophic level wherein the medical care of the injured party is required for the remaining life of the injured party. In this context, the P&C carrier often is required (voluntarily or involuntarily) to provide funds to the injured party over a time range (e.g., for the life of the party in catastrophic personal injury suit, or for a period of time for a surgically implanted product that has found to be defective, or other time periods for time dependent injury). Specific to personal injury, the injured party can develop a future medical care plan which delineates the projected costs of future medical care for the injured party. Such plan can act as basis for the P&C carrier which would have to treat the costs of such future care plan as a contingent liability (e.g., requires the P&C carrier to set aside valuable capital reserve or state incurred but not recorded capital reserved—IBNR—to their balance sheet) which can reduce the P&C carrier's ability to underwrite new policies (i.e., since they would require a capital reserve set aside as well). Similarly, in the context of self-funded insured parties, the cost to fully fund, manage, and oversee the future care plan is substantially onerous and costly.

The complexities of insurance have led to the development of various systems and methods for the creation, management, storage, communication, and display of insurance data. However, current systems do not avail for the creation of a customizable future care insurance plans based on an agreed to future medical care plan through the cooperation of various cooperating third party providers (i.e., self-selected and/or selected based on defined criteria) specifically containing at a minimum at least one excess coverage above a primary health plan providing band coverage to ensure the that the agreed to future medical care plan is deployed throughout the life-term of the intended covered party. Thus, systems exist for the insurance data management methods and systems. However, Applicants have noted that there is a need for an insurance data management platform that employ new paradigms that allow for the creation of customizable future care insurance plans.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The herein described systems and methods provide a computer-implemented interactive system and methods allowing for the creation, management, storage, retrieval, and communication of data representative of at least one customizable future care insurance plan. In an illustrative implementation, the insurance data management environment comprises an insurance data processing engine operable to process data representative of one or more components of a customizable future care insurance plan to create based on a set of selected criteria representative of an exemplary future care plan, and an instruction set comprising at least one instruction to instruct the insurance data processing engine to process the selected criteria data from one or more requesting parties to select from one or more cooperating computing environments data representative of one or more components that would be one or more portions of a future care insurance plan.

In an illustrative operation, the exemplary insurance data processing engine can receive data of one or more requests for the creation of a customized future care insurance plan. Inclusive in the received data can be one or more selection criteria representative of one or more portions of a future care plan (e.g., future medical care plan for an injured party). Responsive to such request, the exemplary insurance data processing engine can cooperate with other computing environments using the one or more selection criteria to request data representative of one or more components of a future care insurance plan. In the illustrative implementation, the selection criteria can comprise data representative of at least one excess coverage component above and beyond a requested primary coverage component, the limits of the excess and primary coverage operatively defined in the selected criteria data. In the illustrative operation, the exemplary insurance data management processing engine can assemble the received data to generate data representative of a future care insurance plan having the requested components as represented by the selection criteria. Illustratively operatively, the exemplary insurance data processing engine can communicate the data generated of the future care insurance plan to one or more cooperating computing environments for subsequent processing (i.e., so that the future care insurance plan can be tracked under the definition of coverage that may be included in the future care insurance plan).

The following description and the annexed drawings set forth in detail certain illustrative aspects of the subject matter. These aspects are indicative, however, of but a few of the various ways in which the subject matter can be employed and the claimed subject matter is intended to include all such aspects and their equivalents.

### BRIEF DESCRIPTION OF THE DRAWINGS

FIG. 1 is a block diagram of an exemplary computing environment in accordance with an illustrative implementation of the herein described systems and methods;

FIG. 2 is a block diagram of an exemplary networked computing environment in accordance with an illustrative implementation of the herein described systems and methods;

FIG. 3 is a block diagram showing the cooperation of exemplary components of an illustrative implementation in accordance with the herein described systems and methods;

FIG. 4 is a block diagram showing an illustrative block representation of an illustrative implementation of an exemplary content management and distribution system in accordance with the herein described systems and methods; and

FIG. 5 is a flow diagram of illustrative processing performed to identify selected content for management/distribution in accordance with the herein described systems and methods.

### DETAILED DESCRIPTION OF ILLUSTRATIVE EMBODIMENTS

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the word “exemplary” is used to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Although the subject matter described herein may be described in the context of illustrative illustrations to process one or more computing application features/operations for a computing application having user-interactive components, the subject matter is not limited to these particular embodiments. Rather, the techniques described herein can be applied to any suitable type of user-interactive component execution management methods, systems, platforms, and/or apparatus.

### Illustrative Computing Environment

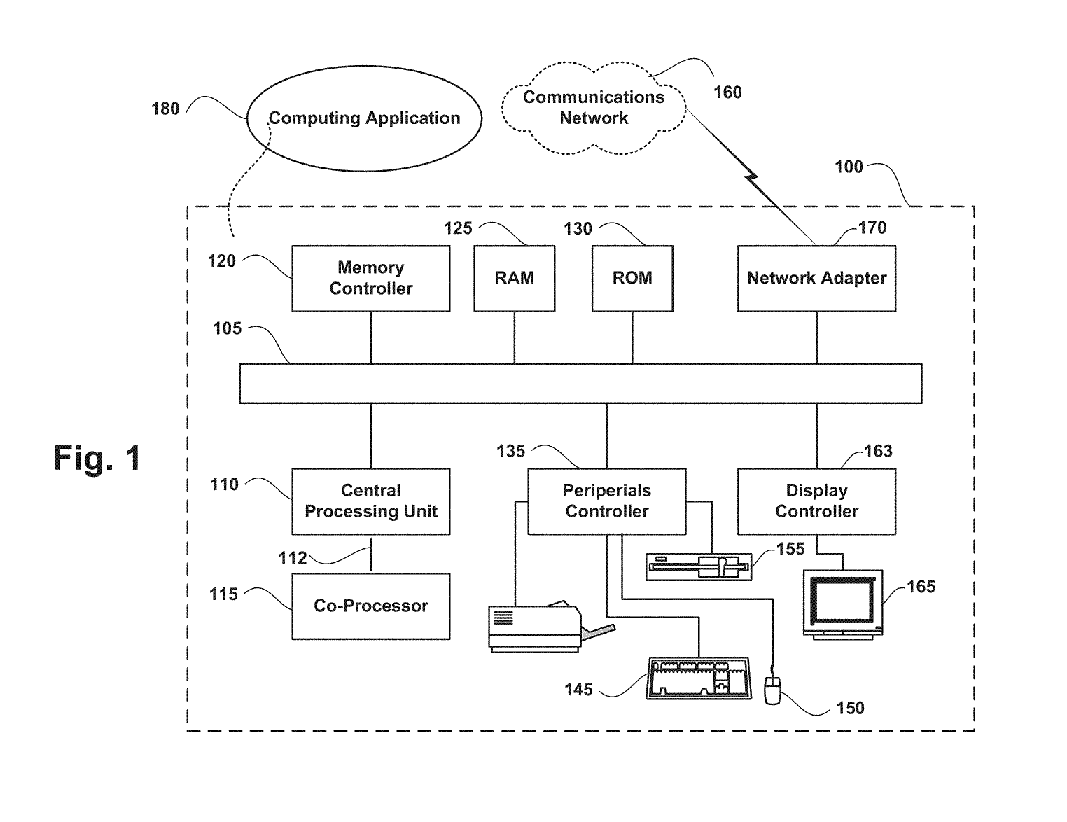

FIG. 1 depicts an exemplary computing system 100 that may be used to implement various aspects of the herein described systems and methods. Referring to FIG. 1, the computing system 100 is capable of executing a variety of computing applications 180. Computing application 180 may comprise, for example, a computing application, a computing applet, a computing program and other instruction set operative on computing system 100 to perform at least one function, operation, and/or procedure. Exemplary computing system 100 is controlled primarily by computer readable instructions, which may be in the form of software. The computer readable instructions can contain instructions for computing system 100 for storing and accessing the computer readable instructions themselves. Such software may be executed within central processing unit (CPU) 110 to cause the computing system 100 to operate. In many known computer servers, workstations and personal computers, CPU 110 is implemented by micro-electronic chips CPUs called microprocessors. A coprocessor 115 is an optional processor, distinct from the main CPU 110 that performs additional functions or assists the CPU 110. The CPU 110 may be connected to co-processor 115 through interconnect 112. One common type of coprocessor is the floating-point coprocessor, also called a numeric or math coprocessor, which is designed to perform numeric calculations faster and better than the general-purpose CPU 110.

In operation, the CPU 110 fetches, decodes, and executes instructions, and transfers information to and from other resources via the computer's main data-transfer path, system bus 105. Such a system bus connects the components in the computing system 100 and defines the medium for data exchange. Memory devices coupled to the system bus 105 include random access memory (RAM) 125 and read only memory (ROM) 130. Such memories include circuitry that allows information to be stored and retrieved. The ROMs 130 generally contain stored data that cannot be modified. Data stored in the RAM 125 can be read or changed by CPU 110 or other hardware devices. Access to the RAM 125 and/or ROM 130 may be controlled by memory controller 120. The memory controller 120 may provide an address translation function that translates virtual addresses into physical addresses as instructions are executed.

In addition, the computing system 100 can contain peripherals controller 135 responsible for communicating instructions from the CPU 110 to peripherals, such as, printer 140, keyboard 145, mouse 150, and data storage drive 155. Display 165, which is controlled by a display controller 163, is used to display visual output generated by the computing system 100. Such visual output may include text, graphics, animated graphics, audio, and video. The display controller 163 includes electronic components required to generate a video signal that is sent to display 165. Further, the computing system 100 can contain network adaptor 170 which may be used to connect the computing system 100 to an external communication network 160.

Computing system 100 may be adapted for use in implementing the systems described herein, including, for example, the content management distribution system, operator computing system, content provider computing system and/or the media/substrates that are described herein.

### Illustrative Computer Network Environment

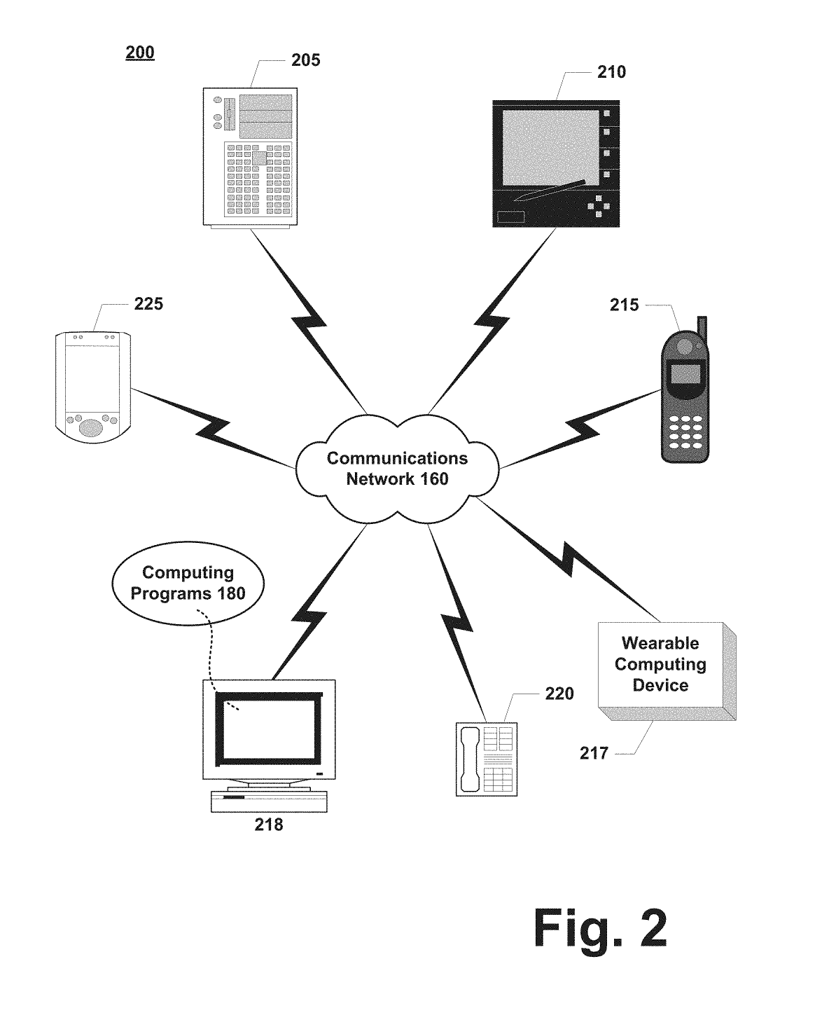

Computing system 100, described above, can be deployed as part of a computer network. In general, the above description for computing environments applies to both server computers and client computers deployed in a network environment. FIG. 2 illustrates an exemplary illustrative networked computing environment, with a server in communication with client devices via a communications network 160, in which the herein described apparatus and methods may be employed. As shown in FIG. 2, server 205 may be interconnected via a communications network 160 (which may be either of, or a combination of a fixed-wire or wireless LAN, WAN, intranet, extranet, peer-to-peer network, virtual private network, the Internet, or other communications network) with a number of client computing environments. Client computing environments may comprise devices such as, for example, tablet personal computer 210, mobile telephone 215, telephone 220, personal computer 218, and, personal digital assistant 225. In connection with the herein described systems and methods, client computing environments may further comprise wearable computing device 217 which may comprise an electronic device adapted to collect insurance data such as, for example, various insurance data to a server system 205. In an exemplary embodiment, wearable computing device 217 may be adapted to display (electronically or otherwise) content received from the server system 205. In connection with the herein described systems and methods, server 205 may be employed, for example, to provide insurance data management services as described herein.

In a network environment in which the communications network 160 is the Internet, for example, server 205 can be dedicated computing environment servers operable to process and communicate data to and from client computing environments 210, 215, 217, 218, 220, and 225 via any of a number of known protocols, such as, hypertext transfer protocol (HTTP), file transfer protocol (FTP), simple object access protocol (SOAP), or wireless application protocol (WAP). Additionally, networked computing environment 200 can utilize various data security protocols such as secured socket layer (SSL) or pretty good privacy (PGP). Each client computing environment 210, 215, 217, 218, 220, and 225 can be equipped with operating system operable to support one or more computing applications, such as a web browser (not shown), or other graphical user interface (not shown), or a mobile desktop environment (not shown) to gain access to server computing environment 205.

During operation, a user (not shown) may interact with a computing application running on a client computing environments to obtain desired data and/or computing applications. The data and/or computing applications may be stored on server computing environment 205 and communicated to cooperating users through client computing environments 210, 215, 217, 218, 220, and 225, over exemplary communications network 160. A participating user may request access to specific data and applications housed in whole or in part on server computing environment 205. These data may be communicated between client computing environments 210, 215, 217, 218, 220, and 225 and server computing environments for processing and storage. Server computing environment 205 may host computing applications, processes and applets for the generation, authentication, encryption, and communication of data and applications and may cooperate with other server computing environments (not shown), third party service providers (not shown), network attached storage (NAS) and storage area networks (SAN) to realize application/data transactions.

### Content Management and Distribution

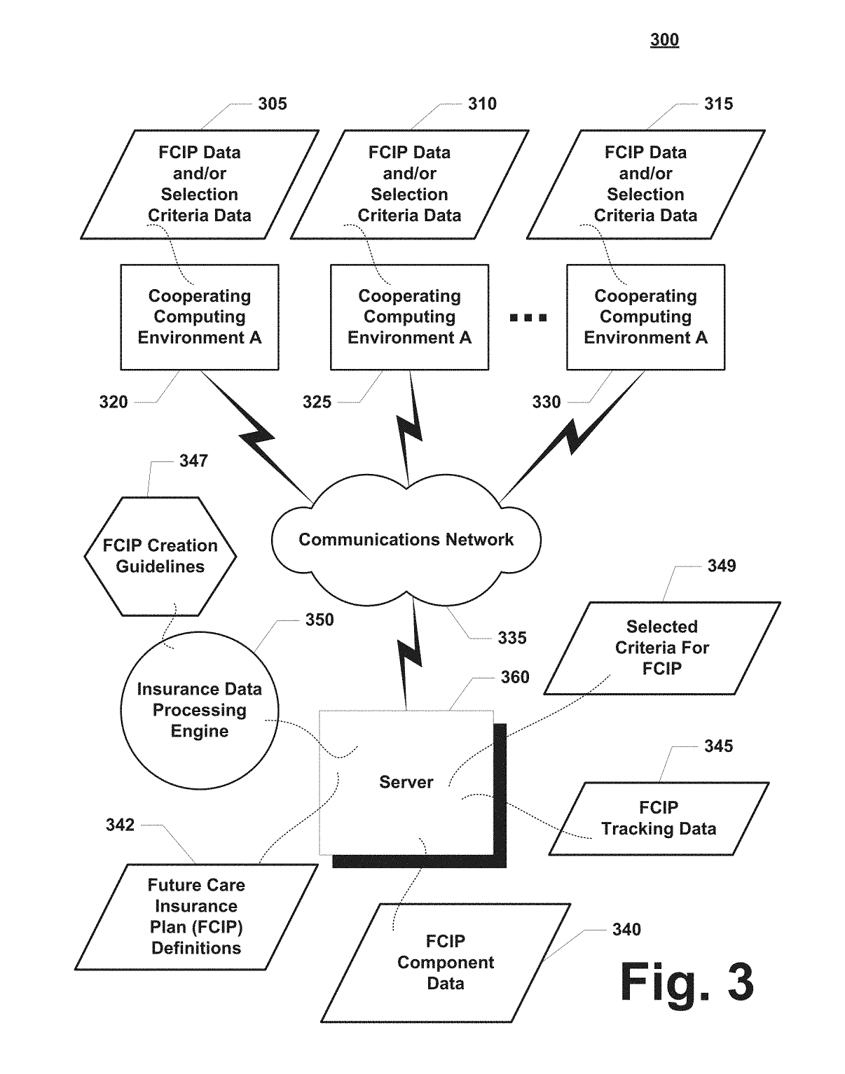

FIG. 3 shows an illustrative implementation of exemplary insurance data processing environment 300. Referring to FIG. 3, exemplary insurance data processing environment 300 comprises one or more cooperating computing environments 320 and 325 through 330. Cooperating computing environments 320, 325, 330 are adapted to display various electronic data (e.g., interactive content or otherwise insurance data) that is forwarded from content server computing environment 360. In an exemplary embodiment, cooperating computing environments 320, 325, and 330 may comprise a display device such as, for example, an LCD display, an LED display, or any other device or surface that is suitable for presenting electronic data.

Cooperating computing environments 320, 325, and 330 are adapted to receive and present future care insurance plan and/or selection criteria data 305, 310, 315, respectively, that may be received via communications network 335 or other mechanism from content server computing environment 360. For example, in an illustrative embodiment, cooperating computing environments 320, 325, and 330 may receive content via network 335 and display the content electronically. FCIP and/or selection criteria data 305, 310, 315 may be any information that may be displayed, viewed, transmitted, searched, copied, retrieved, annotated, navigated, and/or printed from cooperating computing environments 320, 325, and 330, respectively.

In an illustrative embodiment, the data can be communicated to and from cooperating computing environments over communications network 335. Communications network 335 may comprise any communications technologies suitable for communicating electronic data including, for example, WAN, LAN, mobile, internet, wire line, and wireless technologies.

In an illustrative embodiment, insurance data processing engine 350 can operatively execute on server computing environment 360 and is adapted to manage the creation, management, storage, and communication of FCIP data to and from one or more cooperating computing environments 320, 325, and 330 according to one or more selected criteria data 349 to create an exemplary FCIP, one or more FCIP definitions 342 based on one or more FCIP component data 340 and processed according to one or more FCIP creation guidelines 347. In the illustrative embodiment, insurance data processing engine 350 can also process FCIP tracking data 345 representative of data received to and from one or more cooperating computing environments 320, 325 and 330 of the performance of one or more portions of a selected FCIP.

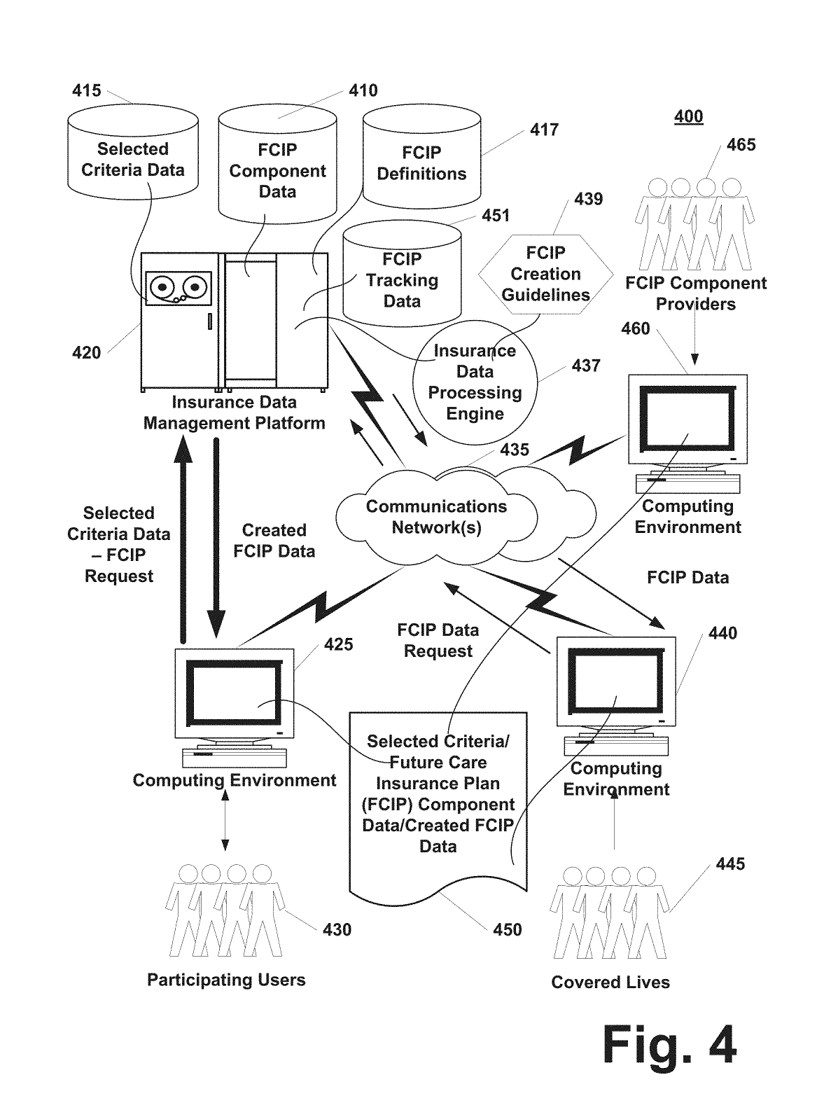

FIG. 4 provides a view of an illustrative implementation of an exemplary insurance data management environment 400. Insurance data management platform 420 operatively cooperates with selected criteria data store 415, future care insurance plan (FCIP) component data store 410, FCIP definitions data store 417, FCIP tracking data 452, and is exemplary operative to execute one or more instruction sets representative of insurance data processing engine 437 having as an input FCIP creation guidelines data/instructions 439. Further, as is shown in FIG. 4, insurance data management platform 420 can illustratively cooperate with other computing environments 425, 460, and or 440 over communications network 435 communicate various data inclusive of created FCIP data 450. In an exemplary implementation, insurance data processing engine 437 may be a software application that executes on insurance data management platform 420 and may employ/execute FCIP creation guidelines 439 (e.g., rules and/or regulations regarding the creation of a healthcare insurance plan/policy that attends to the specific requirements of a future medical care plan for a selected covered party—i.e., injured party), selected criteria data 415, FCIP component data 410, FCIP plan definitions 417 to generate data representative of a customized FCIP 450. Additionally, as is shown in FIG. 4, insurance data management environment 400 can also include FCIP tracking data store 451 that can be operative to store data representative of the performance of one or more services under a FCIP.

In an illustrative implementation, selected criteria data can include specific requested components of a future care insurance plan that is customized for a particular injured covered person. In the illustrative implementation FCIP definitions can include one or more data templates representative of the documents required under various regulatory regimes and rules for the creation of a health insurance policy satisfactory to address the requirements of a select future care medical healthcare plan.

In an illustrative operation, participating users 430 can interact with computing environment 425 to input data representative of a request for the creation of a customized future care insurance plan (FCIP) for communication to insurance data management platform 420 over communications network 435. Insurance data processing engine 437 executing on insurance data management platform 420 can responsively retrieve data from one or more selected data stores 410, 415, 417 and/or another computing environment 460 (e.g., operated by one or more service providers that could provide services under the requested FCIP) according to FCIP creation guidelines for processing by insurance data processing engine 437 to generate data representative of a created FCIP 450 for communication to the covered lives 445 using cooperating computing environment 440 over communications network 435. The created FCIP 450 can be administered and/or serviced by FCIP component provider 465 for the benefit of covered lived 445. Data representative of the performance of services under the created FCIP can be generated by computing environments 440 and/or 460 for communication to insurance data management platform 420 over communications network 435 for storage on FCIP tracking data store 451 for subsequent retrieval/processing.

In an illustrative implementation, participating users 430 can include P&C insurance carriers and/or self-funded seeking a customized future care insurance plan for a specific injured party that meets the conditions of a negotiated future care medical healthcare plan that addresses the injuries specific to that selected party (parties). This requested FCIP can be generated through interaction with third party service/coverage providers that can provide one or more components of the FCIP for communication, administration, and future tracking to the injured party (parties).

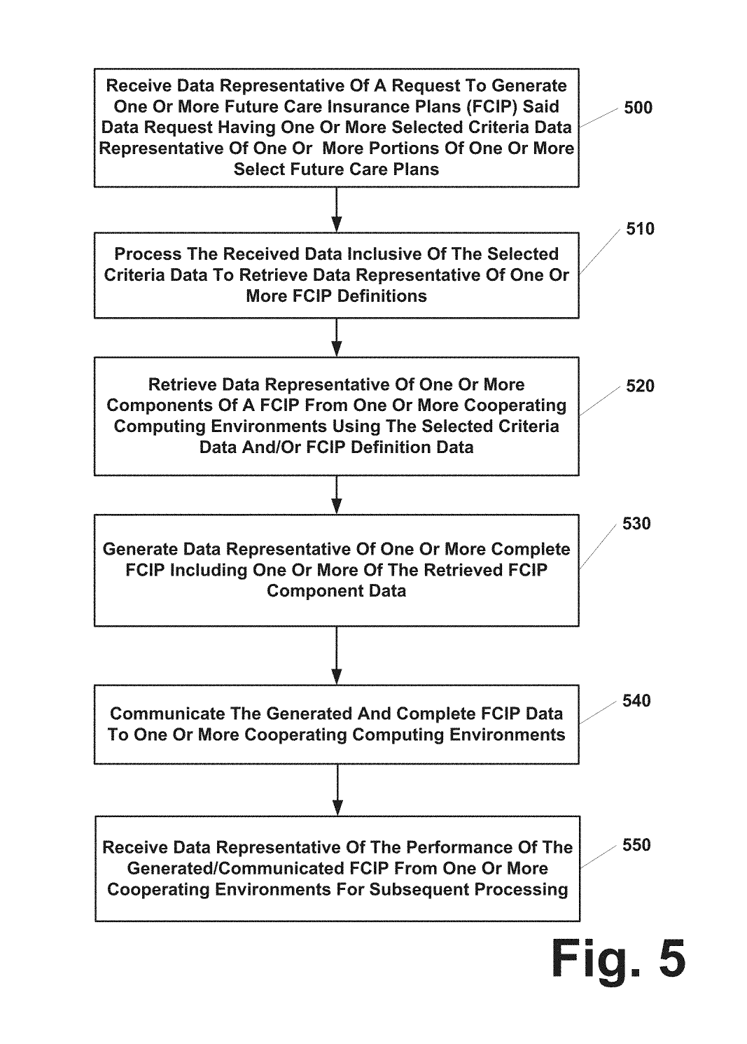

FIG. 5 depicts an exemplary process that may be performed by illustrative insurance data management platform of FIG. 4. As shown, at block 500 data representative of a request to generate one or more future care insurance plans is received such that the received data can include one or more selected criteria data that can be representative of one or more portions of one or more selected future care plans. At block 510, the received data inclusive of the selected criteria data is processed to retrieve one more FCIP definitions from a cooperating data store. At block 520, applying the retrieved one or more FCIP definitions and/or the received one or more selected criteria data, data representative of one or more components of a one or more FCIP is retrieved from one or more cooperating computing environments (e.g., computing environments of one or more third parties that would act as one or more service providers—primary health insurance provider, excess health insurance provider, managed health provider, nurses, assisted living, etc.—that would provide one or more services to realize the requested one or more FCIP).

At block 530, data representative of a complete one or more FCIP is generated, such that the generated one or more completed FCIP data can include one or more of the retrieved FCIP component data. In an illustrative implementation, the one or more completed FCIP data can comprise data of at least one excess carrier coverage plan and at least one primary carrier coverage plan such that the excess carrier coverage plan include as well coverage for one or more third party health services. In the illustrative implementation, the complete one or more FCIP contains one or more FCIP components that can be representative one or more parts of one or more future care medical health plans (e.g., assisted living services, chiropractic services, etc.)

At block 540, data representative of the one or more generated complete FICP is communicated to one or more cooperating computing environments. Correspondingly, data representative of the performance of services included in the communicated one or more generated complete FCIP by one or more cooperating computing environments is received at block 550 for subsequent processing.

Thus, systems and methods for creating, managing, storing, retrieving, processing, communicating, and displaying insurance data have been disclosed. In an exemplary implementation, future care insurance plan data is generated based on received selected criteria data representative of one or more portions of a future care plan. The embodiments and implementations disclosed herein are for exemplary purposes only. Additional embodiments that may not be explicitly disclosed fall within the contemplated implementations. For example, any suitable insurance data processing/management platform can be used to generate a customizable future care insurance plan. Furthermore, any type of future care insurance plan data may be generated responsive to requests to generate a future care insurance plan. Still further, any type of selected criteria/guidelines/rules may be used to generate the FCIP.

The methods and adaptations of the disclosed systems that are described herein can be implemented by computer-executable instructions stored on one or more computer-readable media or conveyed by a signal of any suitable type. The methods can be implemented at least in part manually. The steps of the methods can be implemented by software or combinations of software and hardware and in any of the ways described above. The computer-executable instructions can be the same process executing on a single or a plurality of microprocessors or multiple processes executing on a single or a plurality of microprocessors. The methods can be repeated any number of times as needed and the steps of the methods can be performed in any suitable order.

The subject matter described herein can operate in the general context of computer-executable instructions, such as program modules, executed by one or more components. Generally, program modules include routines, programs, objects, data structures, etc., that perform particular tasks or implement particular abstract data types. Typically, the functionality of the program modules can be combined or distributed as desired. Although the description above relates generally to computer-executable instructions of a computer program that runs on a computer and/or computers, the user interfaces, methods and systems also can be implemented in combination with other program modules. Generally, program modules include routines, programs, components, data structures, etc. that perform particular tasks and/or implement particular abstract data types.

Moreover, the subject matter described herein can be practiced with most any suitable computer system configurations, including single-processor or multiprocessor computer systems, mini-computing devices, mainframe computers, personal computers, stand-alone computers, hand-held computing devices, wearable computing devices, microprocessor-based or programmable consumer electronics, and the like as well as distributed computing environments in which tasks are performed by remote processing devices that are linked through a communications network. In a distributed computing environment, program modules can be located in both local and remote memory storage devices. The methods and systems described herein can be embodied on a computer-readable medium having computer-executable instructions as well as signals (e.g., electronic signals) manufactured to transmit such information, for instance, on a network.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing some of the claims.

It is, of course, not possible to describe every conceivable combination of components or methodologies that fall within the claimed subject matter, and many further combinations and permutations of the subject matter are possible. While a particular feature may have been disclosed with respect to only one of several implementations, such feature can be combined with one or more other features of the other implementations of the subject matter as may be desired and advantageous for any given or particular application.

Moreover, it is to be appreciated that various aspects as described herein can be implemented on portable computing devices and other aspects can be implemented across distributed computing platforms. Likewise, various aspects as described herein can be implemented as a set of services.

It is understood that the herein described systems and methods are susceptible to various modifications and alternative constructions. There is no intention to limit the herein described systems and methods to the specific constructions described herein. On the contrary, the herein described systems and methods are intended to cover all modifications, alternative constructions, and equivalents falling within the scope and spirit of the herein described systems and methods.

It should also be noted that the herein described systems and methods can be implemented in a variety of electronic environments (including both non-wireless and wireless computer environments), partial computing environments, and real world environments. The various techniques described herein may be implemented in hardware or software, or a combination of both. Preferably, the techniques are implemented in computing environments maintaining programmable computers that include a computer network, processor, servers, a storage medium readable by the processor (including volatile and non-volatile memory and/or storage elements), at least one input device, and at least one output device. Computing hardware logic cooperating with various instructions sets are applied to data to perform the functions described above and to generate output information. The output information is applied to one or more output devices. Programs used by the exemplary computing hardware may be preferably implemented in various programming languages, including high level procedural or object oriented programming language to communicate with a computer system. Illustratively the herein described apparatus and methods may be implemented in assembly or machine language, if desired. In any case, the language may be a compiled or interpreted language. Each such computer program is preferably stored on a storage medium or device (e.g., ROM or magnetic disk) that is readable by a general or special purpose programmable computer for configuring and operating the computer when the storage medium or device is read by the computer to perform the procedures described above. The apparatus can also be considered to be implemented as a computer-readable storage medium, configured with a computer program, where the storage medium so configured causes a computer to operate in a specific and predefined manner.

Although exemplary implementations of the herein described systems and methods have been described in detail above, those skilled in the art will readily appreciate that many additional modifications are possible in the exemplary embodiments without materially departing from the novel teachings and advantages of the herein described systems and methods. Accordingly, these and all such modifications are intended to be included within the scope of the herein described systems and methods.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

The herein described systems and methods may be better defined by the following exemplary claims.

What is claimed:

1. An insurance data management system for the generation of a future care insurance plan, comprising:
one or more computing processors; and
a computing memory communicatively coupled with the one or more computing processors, the computing memory having stored thereon computer executable instructions that cause the insurance data management system to perform operations, comprising:
receiving by the insurance data management system, one or more selection criteria to be used in identifying data representative of one or more components of future care medical healthcare plan;
retrieving from one or more cooperating data stores data representative of one or more future care insurance plan definitions comprising data representative of required regulations for a future care insurance plan;
retrieving from one or more cooperating computing environments data representative of one or more components of a future care insurance plan;
the one or more cooperating computing environments operative to provide data for one or more services and/or insurance coverages that can be performed/provided in context of the performance of a future care insurance plan, the future care insurance plan comprising:
data representative of one or more healthcare services that should be performed under the future care medical plan, data representative of one or more third party service/insurance providers that will perform or pay for the performance for the one or more healthcare services, and data representative of the limits on the payments made by the one or more third party insurance providers for the performance of the one or more healthcare services;
applying by the insurance data management system the one or more selection criteria and the data representative of the one or more future care insurance plan definitions in querying associated content data residing on the one or more cooperating data stores and/or the one or more cooperating computing data environments to retrieve future care insurance plan component data;
generating data representative of one or more future care insurance plans; and
communicating the generated one or more future care insurance plans data to one or more cooperating computing environments.

2. The system as recited in claim 1, further wherein the one or more selection criteria data comprises any of text content, graphic content, video content, audio content and a combination thereof.

3. The system as recited in claim 2, wherein the one or more computing environments comprise one or more web-enabled-mobile-enabled computing environments.

4. The system as recited in claim 2, wherein the one or more computing environments comprise a health insurance company computing environment, one or more third party healthcare service provider computing environments, and a third party administrator computing environment.

5. The system as recited in claim 1, wherein the one or more selected criteria data comprises data representative of one or more portions of the future care medical healthcare plan.

6. The system as recited in claim 2, further comprising receiving data representative of the performance of one or more healthcare services from the one or more cooperating computing environment.

7. The system as recited in claim 1, wherein the one or more selection criteria data is provided by a cooperating computing environment operated by a health insurance carrier.

8. The system as recited in claim 1, wherein the one or more selection criteria data is provided by a cooperating computing environment of a self-funded entity that self-funds its coverage for property and casualty risk.

9. The system as recited in claim 1, wherein one or more computing environments comprises a computing environment operated by an excess health insurance carrier.

10. A computer implemented method for managing insurance data for a future care insurance plan, comprising:
at a computing system, receiving by the insurance data management system, one or more selection criteria to be used in identifying data representative of one or more components of future care medical healthcare plan;
at a computing system, retrieving from one or more cooperating data stores data representative of one or more future care insurance plan definitions comprising data representative of required regulations for a future care insurance plan;
at a computing system, retrieving from one or more cooperating computing environments data representative of one or more components of a future care insurance plan,
the one or more cooperating computing environments operative to provide data for one or more services and/or insurance coverages that can be performed/provided in context of the performance of a future care insurance plan, the future care insurance plan comprising:
data representative of one or more healthcare services that should be performed under the future care medical plan, data representative of one or more third party service/insurance providers that will perform or pay for the performance for the one or more healthcare services, and data representative of the limits on the payments made by the one or more third party insurance providers for the performance of the one or more healthcare services;
at a computing system, applying by the insurance data management system the one or more selection criteria and the data representative of the one or more future care insurance plan definitions in querying associated content data residing on the one or more cooperating data stores and/or the one or more cooperating computing data environments to retrieve future care insurance plan component data;
at a computing system, generating data representative of one or more future care insurance plans; and
at a computing system, communicating the generated one or more future care insurance plans data to one or more cooperating computing environments.

11. The system as recited in claim 10, further comprising receiving data representative of one or more selected criteria data comprising data representative of one or more portions of the future care medical healthcare plan.

12. The system as recited in claim 10, further comprising receiving data representative of the performance of one or more healthcare services from the one or more cooperating computing environment.

13. The system as recited in claim 10, further comprising receiving data representative of one or more selection criteria data comprising data provided by a cooperating computing environment operated by a health insurance carrier.

14. The system as recited in claim 10, further comprising receiving data representative of one or more selection criteria data comprising data provided by a cooperating computing environment of a self-funded entity that self-funds its coverage for property and casualty risk.

15. A computer readable storage medium comprising computer readable instructions that, when executed by a computing system cause the computing system to perform operations, comprising:
at a computing system, receiving by the insurance data management system, one or more selection criteria to be used in identifying data representative of one or more components of future care medical healthcare plan;
at a computing system, retrieving from one or more cooperating data stores data representative of one or more future care insurance plan definitions comprising data representative of required regulations for a future care insurance plan;
at a computing system, retrieving from one or more cooperating computing environments data representative of one or more components of a future care insurance plan,
the one or more cooperating computing environments operative to provide data for one or more services and/or insurance coverages that can be performed/provided in context of the performance of a future care insurance plan, the future care insurance plan comprising:
data representative of one or more healthcare services that should be performed under the future care medical plan, data representative of one or more third party service/insurance providers that will perform or pay for the performance for the one or more healthcare services, and data representative of the limits on the payments made by the one or more third party insurance providers for the performance of the one or more healthcare services;
at a computing system, applying by the insurance data management system the one or more selection criteria and the data representative of the one or more future care insurance plan definitions in querying associated content data residing on the one or more cooperating data stores and/or the one or more cooperating computing data environments to retrieve future care insurance plan component data;
at a computing system, generating data representative of one or more future care insurance plans; and
at a computing system, communicating the generated one or more future care insurance plans data to one or more cooperating computing environments.
